(19) United States
(12) Patent Application Publication
(10) Pub. No.: US 2010/0125885 A1
(43) Pub. Date: May 20, 2010

(54) SYSTEM AND METHOD OF PROVIDING NEAR VIDEO ON DEMAND

(75) Inventor: ROHIT SAUHTA, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/274,058

(22) Filed: Nov. 19, 2008

(51) Int. Cl. H04N 7/173

(52) U.S. Cl. 725/101; 725/131; 725/134

(57) ABSTRACT

Aspects include methods, systems, and apparatuses for periodically providing a content item by broadcasting segments of the content item. The method may include identifying a plurality of successive time segments of the content item, wherein each of the time segments is of substantially the same duration; assigning each of the plurality of time segments to one of a plurality of channels, wherein the number of channels is less than the number of time segments; assigning each of the time segments to a periodic time slot of its respective channel; and periodically broadcasting each of the time segments of the content item on the respective assigned channel and in the respective assigned time slot, whereby the content item is made available for uninterrupted playback subsequent to receipt by a receiver of a first portion of the content item.

### BACKGROUND

1. Field

This application relates generally to communications, and more specifically, to communication of multimedia data.

2. Background

Electronic devices such as mobile telephone handsets and other mobile devices may be configured to receive broadcasts of multimedia content items that include sports, entertainment, informational programs, or advertisements. In some instances, the content items may be broadcast periodically or may be broadcast on request of a user of the mobile device. Thus, a need exists for methods and apparatuses for efficiently providing, displaying, and receiving broadcast content items on mobile devices.

### SUMMARY

Methods, systems, and apparatuses or devices of the invention each have several aspects, no single one of which is solely responsible for its desirable attributes. Without limiting the scope of this invention, for example, as expressed by the claims which follow, its more prominent features will now be discussed briefly. After considering this discussion, and particularly after reading the section entitled “Detailed Description” one will understand how the features of this invention provide advantages that include periodically transmitting content items in a way that decreases the amount of time and the number of channels required to transmit the content items.

One embodiment includes a method of transmitting a content item, the method comprising identifying a plurality of successive time segments of the content item, wherein each of the time segments is of substantially the same duration; assigning each of the plurality of time segments to one of a plurality of channels, wherein the number of channels is less than the number of time segments; assigning each of the time segments to a periodic time slot of its respective channel; and periodically broadcasting each of the time segments of the content item on the respective assigned channel and in the respective assigned time slot, whereby the content item is made available for uninterrupted playback subsequent to receipt by a receiver of a first portion of the content item.

Another embodiment includes a method of receiving a content item, the method comprising identifying a plurality of broadcast channels and a respective one of a plurality of time slots of each channel on which a plurality of time segments of the content item are broadcast, wherein the number of channels is less than the number of time segments and wherein the time segments are each of substantially the same duration; and receiving broadcasts of each of the time segments of the content item on the respective identified broadcast channel and during the respective identified time slot, wherein during at least one of the time slots receiving each of the time segments comprises receiving respective time segments on at least two of the identified channels concurrently.

Another embodiment includes method for making available a content item over a plurality of equal delay period start times, comprising dividing the item into substantially equally sized sections, the size of each section corresponding to a size of the delay between start times, and each section having a section order less than the number of sections; assigning each section to a channel such that the section is repeated with a delay that is at most equal to the section order multiplied by the delay period; broadcasting section data corresponding to each assigned channel in accordance with the assigning to provide the content item to a receiver device with a start time having a delay equal to the delay period.

Another embodiment includes method for making available a content item over a plurality of equal delay period start times, comprising dividing the item into substantially equally sized sections, the size of each section corresponding to a size of the delay between start times, and each section having a section order less than the number of sections; broadcasting a first section repeatedly over a first broadcast channel such that the repetition rate is equal to the size of the delay between start times; and broadcasting the subsequent sections over at least a second broadcast channel such that each section is repeated with a delay that is at most equal to the section order multiplied by the delay period, wherein a channel capacity of each broadcast channel is optimized by interleaving sections within the broadcast channel to provide the content item over a plurality of delay period start times.

Another embodiment includes method for making available on a device a content item having one of several start times, the device receiving data from a broadcast source, comprising receiving a first section of a plurality of sections of the content item, each section of said plurality of sections associated with data identifying the content item, and each section of said plurality of sections associated with a section replay order; rendering the first section on the device; identifying at least one other section of said plurality of sections; receiving and storing the at least one other section simultaneously with said rendering of the first section; and rendering the at least one other section by reference to the section replay order of the at least one other section.

Another embodiment includes method for providing a content item on a device, comprising receiving a first section of a plurality of sections of the content item over a first broadcast channel, each section of said plurality of sections associated with data identifying the content item, and each section of said plurality of section associated with a section replay order; identifying that a section of said plurality of sections having a final section order is provided on another broadcast channel; and recording said section having a final section order simultaneously with rendering said first section.

### BRIEF DESCRIPTION OF THE DRAWINGS

FIG. 1 is a block diagram illustrating a system for providing broadcast programming to mobile devices.

FIG. 2 is a block diagram illustrating a mobile device such as illustrated in FIG. 1.

FIG. 3 is a timing diagram illustrating periodically broadcasting a content item according to the prior art.

FIG. 4a is a timing diagram illustrating periodically broadcasting a content item in accordance with an embodiment of the invention, as in the system illustrated in FIG. 1.

FIG. 4b is a timing diagram illustrating periodically broadcasting a content item in accordance with another embodiment of the invention, as in the system illustrated in FIG. 1.

FIG. 5 is a flowchart illustrating a method of broadcasting a content item such as in the system illustrated in FIG. 1.

FIG. 6 is a flowchart illustrating a method of receiving a content item at an electronic device, such as the mobile device illustrated in FIG. 2.

### DETAILED DESCRIPTION

The following detailed description is directed to certain embodiments of the disclosure. However, the invention can be embodied in a multitude of different ways, for example, as defined and covered by the claims. It should be apparent that the embodiments herein may be embodied in a wide variety of forms and that any specific structure, function, or both being disclosed herein is merely representative. Based on the teachings herein one skilled in the art should appreciate that an embodiment disclosed herein may be implemented independently of any other embodiments and that two or more of these embodiments may be combined in various ways. For example, an apparatus may be implemented or a method may be practiced using any number of the embodiments set forth herein. In addition, such an apparatus may be implemented or such a method may be practiced using other structure, functionality, or structure and functionality in addition to or other than one or more of the embodiments set forth herein.

Electronic devices may be configured to receive and display content items broadcast by broadcast systems. In some instances, the broadcast content items may comprise multimedia content items, such as sports programs, entertainment programs, informational programs, or advertisements, among other types of content items.

The content items can be broadcast using any number of different schemes. For example, a content item may be broadcast every time a request is received for that content item. When a large number of requests for the content item are received, however, broadcasting each time a request is received becomes inefficient and in some cases impossible. Not only can resources be conserved by providing one broadcast for multiple requests, but the total number of broadcasts that can be completed in any given period of time is limited by the bandwidth of the system broadcasting the content items. Thus, a compromise should be attained between providing the content item when needed or requested, and providing the content item in an efficient and plausible manner.

One scheme involves broadcasting content items at a predetermined interval. Users wishing to view the content item are apprised of the interval and/or the times at which the broadcast is to start, and can receive a content item at that time. This method is commonly used by providers of “pay-per-view” movies

Frequent periodic broadcasting of movies or other video is often referred to as near video on demand. This is due to the fact that a user who requests or demands a video will receive the video a short time after requesting the video, where the short time period is at most equal to the period of broadcast. Near video on demand can be contrasted with on demand video, by which a video is provided to a user within an insubstantial time in response to a request by the user for the video.

Those skilled in the art will appreciate that the methods, systems, and apparatuses described below are not limited to video content, as described above, but can be utilized with any sort of broadcast content item. In addition, those skilled in the art will appreciate that the periodic interval at which the content is broadcast may vary according to any number of factors. Those skilled in the art will also appreciate that in some instances the methods, systems, and apparatuses described below can be used not only to provide near video on demand, but can also be used to provide other content items nearly on demand, as well as to provide video and other content items on demand.

In one embodiment, a content provider divides a content item into approximately equal time segments and broadcasts the time segments periodically over a plurality of channels, wherein the number of channels is less than the number of segments. The content item is made available for uninterrupted playback subsequent to receipt by a receiver of a first portion of the content item. In another embodiment, the content provider receives a request for an initial one of the time segments of the content item, and transmits, prior to the next periodic broadcast, the initial time segment of the content item in response to receiving the request for the content item. The content item is made available for uninterrupted playback upon receiving at least a portion of the initial time segment

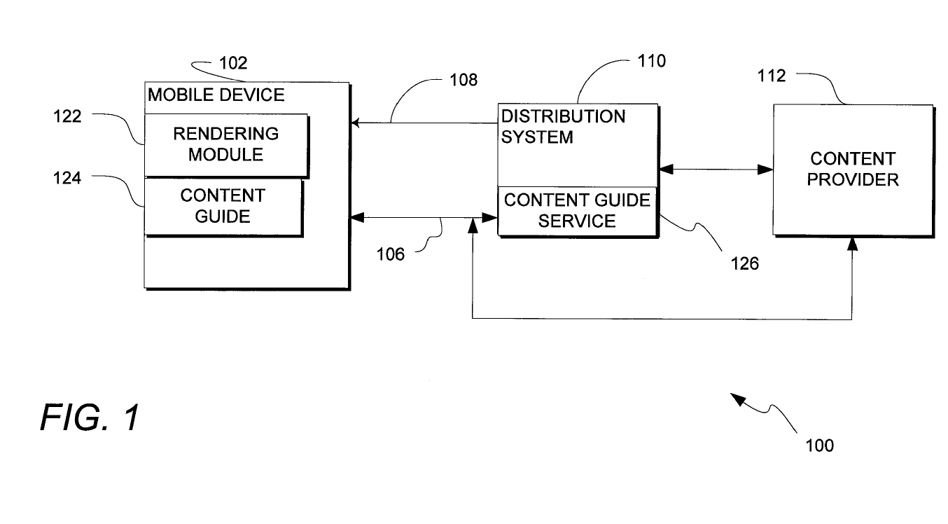

FIG. 1 is a block diagram illustrating a system 100 for providing broadcast content items to mobile devices 102 from one or more content providers 112 via a distribution system 110. While a single mobile device 102 is shown in FIG. 1, examples of the system 100 may be configured to use any number of mobile devices 102. The distribution system 110 may receive data representing a multimedia content item from the content provider 112. The multimedia content items may be communicated over a wired or wireless content communication link 108. In one embodiment, the content communication link 108 is a high speed or broadband link. In one embodiment, the content provider 112 may communicate the content directly to the mobile device 102, bypassing the distribution system 110, via the same or a different communications link. It is to be recognized that in other embodiments multiple content providers 112 may provide content items via multiple distribution systems 110 to the mobile devices 102.

In the system 100 of FIG. 1, the content communication link 108 is illustrated as a unidirectional network. However, the content communication link 108 may also be a fully symmetric bi-directional network. The content communication link 108 may comprise one or more wired and/or wireless links, including one or more of a Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1×EV-DO or 1×EV-DO Gold Multicast) system, an IEEE 802.11 system, a MediaFLO system, a DMB system, an orthogonal frequency division multiple access (OFDM) system, or a DVB-H system.

The content communication link 108 may comprise one or more channels over which content items may be broadcast. A different content item, segment of the content item, or information not relating to content items may be separately broadcast over each channel without interfering with the other channels. In some embodiments, the channels are each comprised of a plurality of subchannels. The channels may be implemented or differentiated using any number methods or strategies. For example, the channels may be logical or virtual channels. In such embodiment, the channels may be defined by a frequency band of a broadcast, modulation of a signal of the broadcast, and/or a code associated with a signal of the broadcast. Those skilled in the art will appreciate other types of channels that may be implemented and other ways in which the implemented channels may be defined. It will be understood that the methods, systems, and apparatuses are not limited to any particular channel.

In the system 100, the mobile device 102 is also configured to communicate on a second communication link 106. In one embodiment, the second communication link 106 is a two way communication link in the system 100, however, the second communication link 106 may also comprise a second link from the mobile device 102 to the distribution system 110 and/or the content provider 112. The second communication link 106 may also be a wireless network configured to communicate voice traffic and/or data traffic. The second communication link 106 may communicate content guide and other data between the distribution system 110 and the mobile device 102. The second communication link 106 may in some embodiments be configured similar to the ways in which the first communication link 108 may be configured.

The mobile device 102 includes a rendering module 122 configured to render the multimedia content items received over the content communication link 108. The rendering module 122 may include analog and/or digital technologies. The rendering module 122 may include one or more multimedia signal processing systems, such as video encoders/decoders, using encoding/decoding methods based on international standards such as MPEG-x and H.26x standards. Such encoding/decoding methods generally are directed towards compressing the multimedia data for transmission and/or storage.

In addition to communicating content items to the mobile device 102, the distribution system 110 may also include a content guide service 126. The content guide service 126 receives content schedule and content related data from the content provider 112 and/or other sources and communicates data representing defining an electronic content guide 124 to the mobile device 102. The electronic content guide 124 may include data related to the broadcast schedule of multiple content items available to be received over the content communication link 108. The electronic content guide data may include titles of programs, start and end times, category classification of programs (e.g., sports, movies, comedy, etc.), quality ratings, adult content ratings, etc. The electronic content guide may further include data regarding how often a content item is broadcasted and over what channels. Of course, this information may be included in other communications or communicated using other means. For example, the electronic content guide 124 or other content information may also be communicated to the mobile device 102 over the content communication link 108 and stored in the mobile device 102.

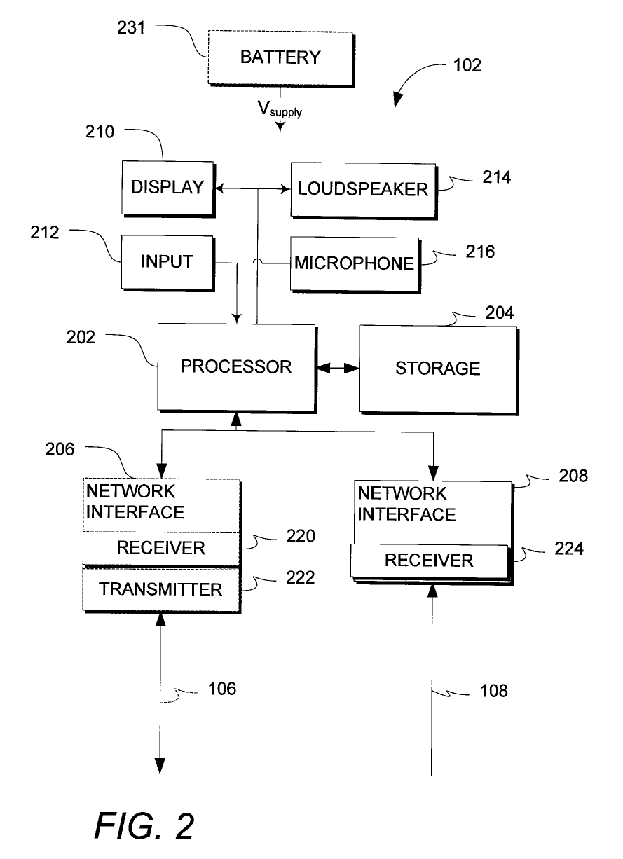

FIG. 2 is a block diagram illustrating the mobile device 102 such as illustrated in FIG. 1. The mobile device 102 includes a processor 202 that is in communication with a storage 204 and a network interface 208 that communicates over the content communication link 108. The network interface 208 includes a receiver 224 configured to receive the unidirectional content communication link 108. The network interface 208 and receiver 224 may receive signals according to wired and/or wireless technologies and/or links, such as those described with reference to the content communication link 108.

The mobile device 102 may include an optional second network interface 206 for communicating via the bi-directional second communication link 106. The second network interface 206 may include any suitable antenna (not shown), a receiver 220, and a transmitter 222 so that the mobile device 102 can communicate with one or more devices over the second communication link 106. Optionally, the second network interface 206 may also have processing capabilities to reduce processing requirements of the processor 202.

The mobile device 102 also includes one or more of a display 210, a user input device 212 such as a keypad, touch screen, or other suitable tactile input device, a loudspeaker 214 comprising a transducer adapted to provide audible output based on a signal received over the second communication link 106 and/or the content communication link 108, and/or a microphone 216 comprising a transducer adapted to provide audible input of a signal that may be transmitted over one or both of the second communication link 106 and content communication link 108.

The mobile device 102 may optionally include a battery 231 to provide power to one or more components of the mobile device 102. The mobile device 102 may comprise at least one of a mobile handset, a personal digital assistant, a laptop computer, a headset, a vehicle hands free device, or any other electronic device. For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, or any other suitable device.

The components described herein may be implemented in a variety of ways. Referring to FIG. 2, the mobile device or apparatus 102 is represented as a series of interrelated functional blocks that may represent functions implemented by, for example the processor 202, software, some combination thereof, or in some other manner as taught herein. For example, the processor 202 may facilitate user input via the input device 212. Further, the transmitter 222 may comprise a processor for transmitting that provides various functionalities relating to transmitting information to another mobile device 102. The receiver 220 may comprise a processor for receiving that provides various functionalities relating to receiving information from another mobile device 102.

The mobile device 102 may be configured to receive data concurrently from one or both of the second communication link 106 and content communication link 108. In one embodiment, reception or display of a broadcast of a program may be discontinued over the content communication link 108 when a signal, e.g., a telephone call for example, is received over the second communication link 106.

The mobile device 102 is configured to receive broadcasts over a plurality of channels, for example channels comprising the content communication link 108, simultaneously. Content received over this plurality of channels may be rendered at least on the display 210 or may be stored by the processor 202 in the storage 204. In some embodiments, the processor 202 is configured to cause the display of content at the same time as receiving content over at least one of the plurality of channels. This displayed content may be displayed as it is being received over one of the channels, known as “streaming,” or it may be retrieved from the storage 204. Display of content may also be referred to as playback of the content.

As noted above, FIG. 2 illustrates that in some aspects these components may be implemented via appropriate processor components. These processor components may in some aspects be implemented, at least in part, using structure as taught herein. In some aspects, a processor may be adapted to implement a portion or all of the functionality of one or more of these components. In some aspects one or more of the components represented by dashed boxes are optional.

In some aspects, the mobile device or apparatus 102 may comprise an integrated circuit. Thus, the integrated circuit may comprise one or more processors that provide the functionality of the processor components illustrated in FIG. 2. For example, in some aspects a single processor may implement the functionality of the illustrated processor components, while in other aspects more than one processor may implement the functionality of the illustrated processor components. In addition, in some aspects the integrated circuit may comprise other types of components that implement some or all of the functionality of the illustrated processor components.

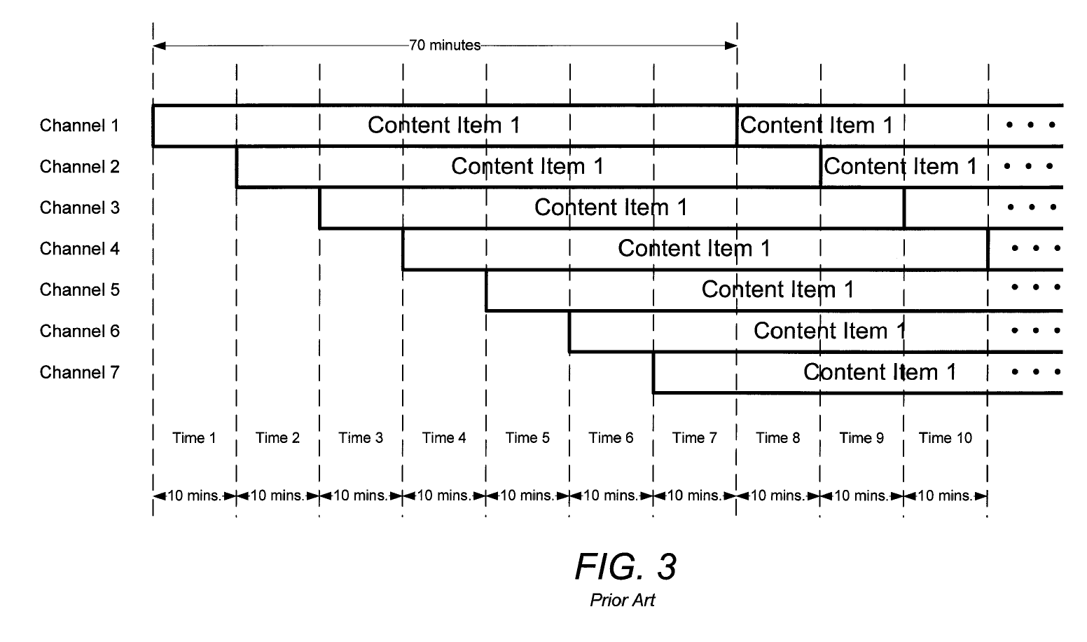

FIG. 3 is a timing diagram illustrating periodically broadcasting a content item, such as by the system 100 illustrated in FIG. 1, according to the prior art. For example, the distribution system 110 may broadcast content items according to the timing diagram illustrated in FIG. 3. In the illustrated broadcasting, Content Item 1 is broadcast and is 70 minutes long. Content Item 1 may, for example, be a movie or television show.

In the illustrated broadcasting, Content Item 1 is broadcast every 10 minutes. Thus, a user wishing to view Content Item 1 will have to wait at most 10 minutes to start viewing Content Item 1 from the beginning. A user wishing to view Content Item 1 may, however, have to wait less than 10 minutes to start viewing Content Item 1 from the beginning.

Content Item 1 is first broadcast in its entirety on Channel 1, starting at the beginning of Time 1. The broadcast continues for the length of Content Item 1, which is 70 minutes. The broadcast of Content Item 1 will therefore be completed at the end of Time 7. Content Item 1 may thereafter be broadcast again starting at the beginning of Time 8, or after a predetermined delay. This repetition of broadcast may continue for as long as a content provider wishes for Content Item 1 to be viewable by users of the system 100.

In order for Content Item 1 to be available from its beginning 10 minutes after Content Item 1 is first broadcast at the beginning of Time 1, Content Item 1 is broadcast again in its entirety on Channel 2, starting 10 minutes later at the beginning of Time 2. The broadcast continues for the length of Content Item 1, which is 70 minutes, and will end at the end of Time 8. Content Item 1 can then be broadcast again on Channel 2, starting at the beginning of Time 9.

Content Item 1 is thereafter broadcast every 10 minutes on Channels 3-7. For a content item to be periodically available to a user, the number of channels Cₚᵣ over which the content item is broadcast in this prior art broadcasting must satisfy equation (1):

$$Cpr = ⌈ \frac{L}{P} ⌉ \qquad ( 1 )$$

wherein L is the length of the content item and P is the period at which the content item is to be provided. For example, in order to broadcast a 28 minute content item every 5 minutes, the number of channels required is 6. Thus, the 70 minute Content Item 1 requires seven channels in order to be broadcast every 10 minutes.

After the broadcast of Content Item 1 is complete on each channel, Content Item 1 may thereafter be broadcast again on that channel. As represented by ellipses in FIG. 3, the broadcast of Content Item 1 may continue on Channels 1-7 after Time 10, which is where illustration of the timing diagram stops.

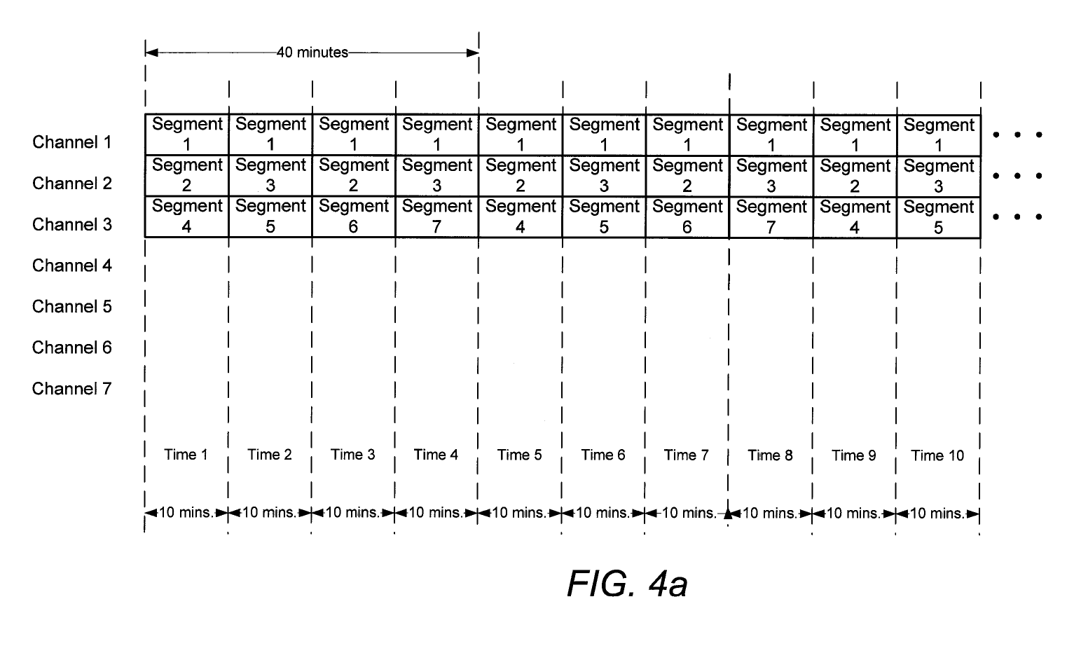

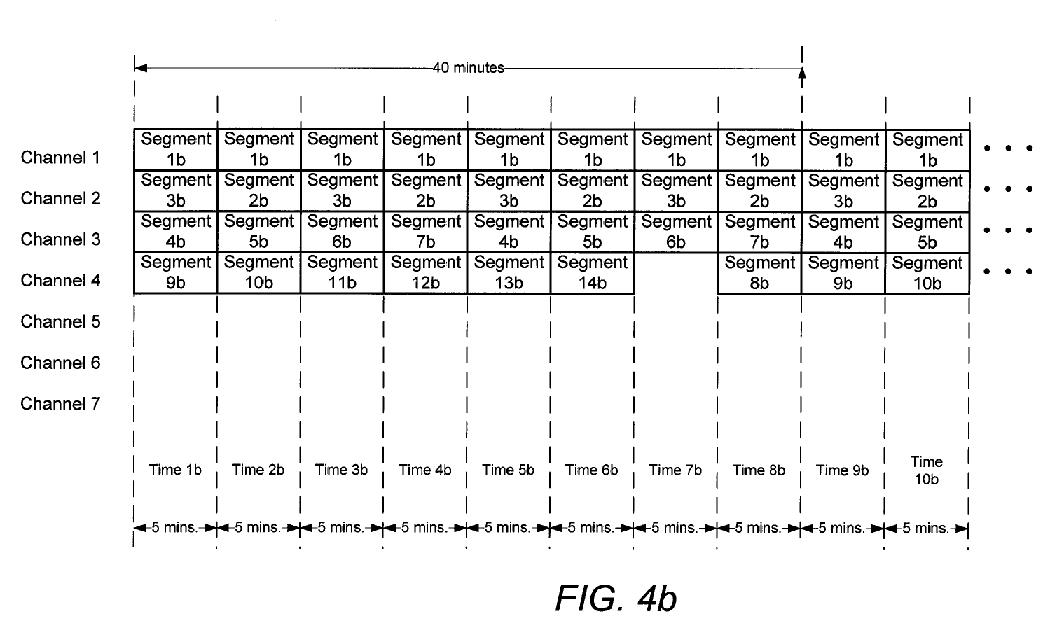

FIG. 4a is a timing diagram illustrating periodically broadcasting Content Item 1, such as by the system 100 illustrated in FIG. 1, in accordance with an embodiment of the invention. For example, the distribution system 110 may broadcast content items according to the timing diagram illustrated in FIG. 4a. In the illustrated embodiment, Content Item 1 is still to be provided in its entirety every 10 minutes, similar to the period at which Content Item 1 was provided in FIG. 3.

In FIG. 4a, Content Item 1 has been separated into Segments 1-7. Each of Segments 1-7 are of a length that is substantially equivalent to the period at which the content item is to be provided. In the illustrated embodiment, Segments 1-7 are approximately 10 minutes in length each. In the case that a length of a content item does not divide evenly, then all but one of the segments will have a length that is substantially equal to the period, while the last segment will have a length that is substantially equal to the remainder obtained when the length of the content item is divided by the length of the period. In such case, the segments are still considered to be substantially of the same size for purposes of this invention. Segments of a content item may also be referred to herein as time segments or as sections.

The number of segments N required for a content item can be described with the following equation (2):

$$N = ⌈ \frac{L}{P} ⌉ \qquad ( 2 )$$

wherein L is again the length of the content item and P is again the period at which the content item is to be provided. For example, a content item that is 32 minutes long and is made available every 5 minutes will be divided into 7 segments. Thus, the 70 minute Content Item 1 is divided into 7 segments in order to be broadcast every 10 minutes.

In the illustrated embodiment, the segment numbers represent an order of the data contained in Content Item 1. Thus, Segment 1 contains the first 10 minutes of data required for display of Content Item 1. Segment 2 contains the next 10 minutes. Similarly, Segments 3-7 contain subsequent 10 minute data segments required for display of Content Item 1 and are ordered appropriately.

Segment 1 is broadcast on Channel 1 starting at the beginning of Time 1. Due to Segment 1 being of substantially the same length as the period at which Content Item 1 is to be provided, broadcast of Segment 1 will be completed at the end of Time 1. Segment 1 can thereafter be broadcast again at the beginning of Time 2. In the illustrated embodiment, broadcast of Segment 1 is repeated every 10 minutes for as long as Content Item 1 is to be made available to users.

Segments 2 and 4 are also broadcast starting at the beginning of Time 1. In the illustrated embodiment, Segments 2 and 4 are broadcast on Channels 2 and 3, respectively. Similar to Segment 1, broadcast of Segments 2 and 4 will be completed at the end of Time 1. In contrast to Segment 1, however, Segments 2 and 4 are not immediately broadcast again at the beginning of Time 2.

Instead of broadcasting Segments 2 and 4 again at the beginning of time 2, the segments following each of Segments 2 and 4 are broadcast on Channels 2 and 3, respectively, at the beginning of Time 2. Thus, Segments 3 and 5 are broadcast at the beginning of Time 2. Following broadcast of Segments 3 and 5, Segment 2 is again broadcast on Channel 2. Following such broadcast, Segment 3 is again broadcast on Channel 2. Segments 2 and 3 can continue broadcast in this way for as long as Content Item 1 is to be made available to users.

After Segment 5 has been broadcast on Channel 3, Segment 6 is broadcast on Channel 3 at the beginning of Time 3. After Segment 6 is broadcast, Segment 7 is broadcast on Channel 3 at the beginning of Time 4. Thereafter, Segment 4 is again broadcast on Channel 3 at the beginning of time 5. Segments 5-7 may then again be broadcast on Channel 3 at Times 6-8, respectively. Broadcast of Segments 4-7 can continue in this order for as long as Content Item 1 is to be made available to users.

A user who begins receiving Content Item 1 at the beginning of Time 1 can stream Segment 1 with an electronic device, such as the mobile device 102 illustrated in FIG. 2. Thus, the mobile device 102 can render or display Segment 1 as Segment 1 is being received at Time 1. Simultaneous with receiving Segment 1, the mobile device 102 can receive and store, or record, Segments 2 and 4. At Time 2, the mobile device 102 can render stored Segment 2 while receiving and storing Segments 3 and 5. At Time 3, the mobile device 102 can render the stored Segment 3 while receiving and storing Segment 6. At Time 4, the mobile device 102 can render Segment 4 while receiving Segment 7.

At the end of Time 4, the mobile device 102 will have received all seven segments of Content Item 1. Thus, the entirety of Content Item 1 will have been broadcast in 40 minutes. The broadcast of Content Item 1 in this embodiment requires 30 minutes less time than the broadcasting described in relation to FIG. 3. In order for a user to view the entire Content Item 1, however, the mobile device 102 will have to render the segments for the full 70 minutes. The remaining Segments 5-7 can be rendered from storage at Times 5-7, respectively. Even so, the mobile device 102 will not be required to receive content for this entire time, but only for 40 minutes. In some embodiments, segments of a content item are broadcast quicker than they can be rendered by an electronic device.

A user who begins receiving Content Item 1 on the mobile device 102, for example, at the beginning of Time 2 will similarly be able to receive the entirety of Content Item 1 in 40 minutes. The mobile device 102 will stream Segment 1 and receive and record Segment 5 at Time 2. The mobile device 102 will then stream Segment 2 and receive and record Segment 6 at Time 3. Next, the mobile device 102 will stream Segment 3 and receive and record Segment 7 at Time 4. Following this, the mobile device 102 will stream Segment 4 at Time 5. At the end of Time 5, the entirety of Content Item 1 will have been received in 40 minutes. At times 6-8, the mobile device 102 may render Segments 5-7, respectively, from storage.

Those skilled in the art will appreciate that a user who begins receiving Content Item 1 at the beginning of Times 3 or 4 will similarly be able to receive the entirety of Content Item 1 in 40 minutes. Reception of Content Item 1 starting at the beginning of Time 5 follows the same process of reception of Content Item 1 starting at the beginning of Time 1.

According to some embodiments, a user is able to receive Content Item 1 over a period of time longer than 40 minutes if reception of Content Item 1 begins at an appropriate time. For example, a user who begins receiving Content Item 1 at the beginning of Time 2 may stream Segment 1 over Channel 1 with the mobile device 102, for example. At Times 3-4, the mobile device 102 can stream Segments 2-3 over Channel 2. At Times 5-8, the mobile device 102 can stream Segments 4-7 over Channel 3. Thus, Content Item I will have been received over a period of 70 minutes. In this way, a user can avoid receiving data over a plurality of channels at the same time. Of course, the mobile device 102 may instead receive and store one or all of Segments 3-7 while receiving and/or rendering a previous segment. Then, those stored segments can be subsequently rendered from storage instead of being streamed.

In the illustrated embodiment, the broadcast of Content Item 1 is repetitious after every four time segments, and therefore the reception of Content Item 1 is repetitious after every four time segments. It can thus be seen that Content Item 1 can periodically be provided in its entirety for uninterrupted playback by broadcasting according to FIG. 4a. As represented by ellipses in FIG. 4a, the broadcast of Content Item 1 may continue on Channels 1-3 after Time 10, which is where illustration of the timing diagram stops.

Not only may Content Item 1 be broadcast in 30 minutes less time in FIG. 4a than in FIG. 3, but Content Item 1 is broadcast at the same periodic rate using only 3 channels. The broadcasting illustrated in FIG. 3 required 7 channels, or four more than the broadcasting illustrated in FIG. 4a. As can be seen from this information, Content Item 1 can be broadcast according to FIG. 4a at the same periodic rate as in FIG. 3, but the broadcasting illustrated in FIG. 4a requires almost half the time and under half of the channels. Those of skill in the art will recognize that these realized advantages will vary according to a length of a content item and a periodic rate at which the content item is to be provided. Additionally, the content item may broadcast over a greater number of channels, as will be described in further detail below.

The number of channels C_{emb} required to transmit a content item according to the current embodiment is defined by the following equation (3):

└Log₂(N)┘<C_{emb}≦┐Log₂(N+1)┐ (3)

wherein N is the number of segments of the content item as defined in equation (2) above. Those of skill in the art will recognize that the number of channels C_{emb} can be defined by other equations, such as equations (3a) and (3b), but is not limited to these enumerated expressions:

└Log₂(N)┘<C_{emb}≦└Log₂(N)┘+1 (3a)

└Log₂(N)┘<C_{emb}≦└Log₂(2N)┘ (3b)

wherein N is again the number of segments of the content item as defined in equation (2). For example, a content item containing 4 segments would require between 2 and 3 channels-more than 2 channels and less than or equal to 3 channels—as further described below.

Those of skill in the art will recognize that broadcast of a content item may not completely utilize every required channel. To illustrate this, consider the example above wherein a content item comprises 4 segments. As can be seen by reference to FIG. 4a, the content item can be broadcast on Channels 1-3. When Segments 5-7 are omitted from FIG. 4a, nothing will be broadcast on Channel 3 during Times 2-4. Although Channel 3 is required, it is not completely utilized. Hence, broadcast of the content item will not require 3 full channels. Instead, other blocks of data unrelated to the content item may be broadcast over Channel 3 during Times 2-4, 6-8, etc. Also, those of skill in the art will recognize that Segment 4 can be broadcast at any one of Times 1-4 and that the other data can be broadcast around Segment 4 if the order of broadcasting Segment 4 and the other data is maintained during subsequent broadcasting times following Times 1-4.

Consider another example wherein a content item comprises 5 segments. Again with reference to FIG. 4a, it can be seen that the content item can be broadcast on Channels 1-3. When Segments, 6-7 are omitted from FIG. 4a, nothing will be broadcast on Channel 3 during Times 3-4. Instead, other blocks of data unrelated to the content item may be broadcast over Channel 3 during Times 3-4, 7-8, etc. Alternatively, Segments 4 and 5 can again be broadcast at Times 3-4, respectively. In this way, a user who begins receiving the content item at the beginning of Time 3 will be able to receive the entire content item by the end of Time 4, and Channel 3 will be completely utilized by the broadcast of the content item.

Those of skill in the art will understand that the equation (3) does not limit the number of channels that may be used to broadcast a content item, but rather defines the minimum number of channels required to broadcast the content item according to the present embodiment. For example, Segments 4-5 of Content Item 1 may be repetitiously broadcast over Channel 3 and Segments 6-7 may be repetitiously broadcast over Channel 4 instead of being broadcast over Channel 3. According to this example, 4 channels will be used, but the entire Content Item 1 may be received in 20 minutes.

If the above example is taken to the extreme, each segment of Content Item 1 may be broadcast on a separate channel. Broadcasting Content Item 1 in this way will require the same number of channels as the broadcasting illustrated in FIG. 3, but devices configured to receive segments of Content Item 1 simultaneously over separate Channels may receive Content Item 1 in a shorter period of time. In the present example, the entire Content Item 1 could be received in 10 minutes over 7 separate channels. Or, Content Item 1 could be received over a time period equal to any multiple of 10 minutes if segments are not simultaneously received over all 7 channels. Those of skill in the art will understand that any number of channels equal to or greater than C_{emb}, as defined in equation (3), can be utilized to broadcast a content item.

In the illustrated embodiment of FIG. 4a, the channel numbers can also be referred to as the section order of each segment being broadcast over that channel. Thus, Segment 1 has a section order of 1. Segments 2-3 have a section order of 2. Segments 4-7 have a section order of 3. If Content Item 1 were comprised of a greater number of segments, Segments 8-15 would have a section order of 4. Segments 16-31 would have a section order of 5, and so forth. The section order S of any segment may be determined by the following equation (4):

S=┌Log₂(n+1)┐ (4)

wherein n is the number of the segment (as opposed to N, which is the total number of segments of a content item as defined in equation (2) above). In some embodiments, the section order may be defined using a different expression according to a design of the system 100 illustrated in FIG. 1 or according to a broadcast strategy.

In the illustrated embodiment, segments having the same section order are broadcast over the same channel. The specific channel that is used for such broadcast, however, may be numbered, labeled, or ordered different from the channels illustrated in FIG. 4a.

FIG. 4b is a timing diagram illustrating periodically broadcasting Content Item 1, such as by the system 100 illustrated in FIG. 1, in accordance with another embodiment of the invention. For example, the distribution system 110 may broadcast content items according to the timing diagram illustrated in FIG. 4b.

In the illustrated embodiment, Content Item 1 is to be provided in its entirety every 5 minutes, which is half the period at which Content Item 1 was provided in FIGS. 3 and 4a. Using equation (2) with L equal to 70 minutes, and P equal to 5 minutes, it can be determined that 14 segments are required for Content Item 1. Each of Segments 1b-14b are 5 minutes in duration.

Using equation (3) with N equal to 14, it can be determined that between 3 and 4 channels are required to provide Content Item 1 every 5 minutes. As can be seen in FIG. 4b, Content Item 1 is broadcast over 4 channels, but nothing is broadcast over Channel 4 at Time 7b. Similarly, nothing will be broadcast at Times 15b, 23b, etc. Channel 4 may be free from broadcast during these times, as illustrated, or additional data may be broadcast during these times. The additional data may or may not be related to Content Item 1, but no data related to Content Item 1 is required to be broadcast during these times.

Those of skill in the art will appreciate that a user who starts receiving Content Item 1 at the beginning of Time 1b may finish reception of Content Item 1 at the end of Time 8b, similar to the reception of Content Item 1 during Times 1-4 illustrated in FIG. 4a. It will be further appreciated that a user starting reception of Content Item 1 at the beginning of any of Times 2b-8b may similarly receive the entirety of Content Item 1 by the end of Times 9b-15b, respectively.

In the illustrated embodiment, the broadcast of Content Item 1 is repetitious after every eight time segments, and therefore the reception of Content Item 1 is repetitious after every eight time segments. It can thus be seen that Content Item 1 can periodically be provided in its entirety for uninterrupted playback by broadcasting according to FIG. 4b. It will take a user a minimum of 40 minutes to receive Content Item 1 using the broadcasting illustrated in FIG. 4b, which is similar to the amount of time required to receive Content Item 1 using the broadcasting illustrated in FIG. 4a. In FIG. 4b, however, Content Item 1 is provided every 5 minutes, as opposed to every 10 minutes as illustrated in FIG. 4a. As represented by ellipses in FIG. 4b, the broadcast of Content Item 1 may continue on Channels 1-4 after Time 10b, which is where illustration of the timing diagram stops.

In FIG. 4b, Segment 2b is broadcast with Segments 5b and 7b. Segment 3b is broadcast with Segments 4b and 6b. Thus, Segments 2b and 3b are broadcast at different times relative to Segments 4b-7b than the times at which Segments 2-3 are broadcast relative to Segments 4-7 in FIG. 4a. Broadcasting the Segments 2b-3b in this order, combined with the broadcast of Segments 8b-14b in the order shown, ensures that a user receiving the segments will have to receive segments over at most three channels at a time. In fact, users who start reception of Content Item 1 at any of Times 1b-7b will only have to received segments on at most two channels at a time to ensure uninterrupted display of Content Item 1 after a first portion of Content Item 1 is received. Only users who start receiving Content Item 1 at the beginning of Time 8b will have to receive segments over three channels at a time to ensure uninterrupted display of Content Item 1 after a first portion of Content Item 1 is received.

If Segments 2b and 3b were broadcast at Times 1b and 2b, respectively, and Segments 8b-14b were broadcast at Times 1b-7b, respectively, a user who starts receiving Content Item 1 at the beginning of Time 1b would need to receive segments over all four channels simultaneously to guarantee uninterrupted playback of Content Item 1. Additionally, users who start receiving Content Item 1 at the beginning of Times 5b and 8b would need to receive segments over three channels simultaneously to guarantee uninterrupted playback of Content Item 1. Thus, the broadcasting illustrated in FIG. 4b is more optimized for reducing the maximum number of channels over which a user will have to receive segments than is the broadcasting illustrated in FIG. 4a.

Those skilled in the art will appreciate that the order in which segments are broadcast on various channels and the number of channels used to broadcast segments may be optimized in different ways and for different reasons. For example, the order in which Segments 2b-14b is broadcast in FIG. 4b may be further changed to provide a different broadcasting embodiment that is also directed to reducing the maximum number of channels over which a user must receive segments of Content Item 1. Alternatively, the order of segments may be optimized to reduce the number of segments that must be stored in a storage of a mobile device receiving Content Item 1. As another example, the number of channels may be optimized for reducing the time required to receive Content Item 1.

As discussed above, segments of a content item having a similar section order are broadcast on the same channel. Segments broadcast on the same channel may be broadcast in any order, so long as broadcast of each segment is repeated no less often than a time T defined by the following equation (5):

T≦S*P (5)

wherein S is the section order defined in equation (4) above, and P is again the period at which the content item is to be provided. Thus, a delay between repeated broadcast of each segment is not more than T. In some embodiments, segments having a similar section order are broadcast over different channels and at different intervals, and in some embodiments the section order S in equation 5 is defined by an expression other than equation (4).

Although the broadcasting of FIG. 4b is illustrated as having myriad differences from the broadcasting illustrated in FIG. 4a, the broadcasting of FIG. 4b can be configured the similar to the broadcasting of FIG. 4a. Those of skill in the art will understand that the embodiments illustrated in FIGS. 4a and 4b are merely exemplary and are not limiting on the present invention. The length of Content Item 1, length of the Times 1-10, length of the Times 1b-14b, time labels, number of channels, and channel labels in FIGS. 4a and 4b are merely illustrative. The length of Content Item 1, Times 1-10, Times 1b-14b and the period at which Content Item 1 is to be provided may be embodied as any length of time. Similarly, the number of channels used to broadcast Content Item 1 may be more than shown and may be numbered or designated in a variety of ways. Those of skill in the art will appreciate other modifications as well.

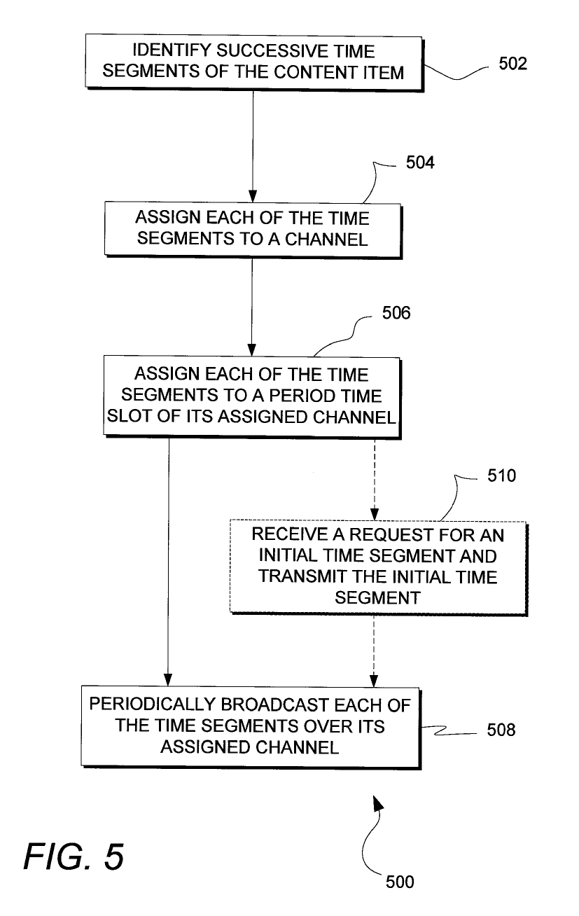

FIG. 5 is a flowchart illustrating a method 500 of broadcasting a content item such as in the system 100 illustrated in FIG. 1. The acts or events associated with the method 500 may be performed by different configurations of the system 100 than those herein described. Those skilled in the art will know how to extend the method described to different configurations of the system 100 and will understand that different components within the system 100 may perform the method than are herein described.

At block 502, successive time segments of a content item, which are to be broadcast in the broadcast system 100, are identified. The time segments may be identified by different devices or modules within the system 100. For example, the distribution system 110 may identify the successive time segments according to a predetermined period at which the content item is to be provided or according to an order of broadcast of the time segments. The content guide service 126 may identify the time segments according to when the segments will be broadcast to the mobile device 102. The content provider 112 may identify the time segments according the way in which the content item will be provided to the distribution system 110.

In some embodiments, the content item has already been divided into the separate time segments before block 502. Thus, at block 502, the successive time segments must merely be identified for broadcast. In other embodiments, the time segments may be marked or appended with information regarding their order of viewing or order in relation to the other time segments.

In some embodiments, the content item is divided into time segments at block 502 or after completion of block 502. The division of the content item is executed such that each time segment is of substantially the same duration. As explained in reference to FIG. 4a, the duration may be substantially equal to the period at which the content item is to be provided. In such case, the number of time segments created will be defined by equation (2). The content item may be divided by different devices or modules within the system 100.

At block 504, each of the time segments is assigned to a broadcast channel. As described above in reference to FIG. 4a, the time segments may be assigned to a broadcast channel based on a section order of each of the time segments. The section order is defined by equation (4). In this case, time segments having a similar section order are assigned to the same channel. How the channels are defined or numbered may vary and does not affect operation of the method 500.

In some embodiments, the assignment of the time segments to a plurality of channels is optimized, such as to minimize the time necessary to transmit the content item. Such optimization may involve balancing the bandwidth available to transmit the content item or the number of free channels in the system 100.

The time segments may be assigned to a channel by different devices or modules within the system 100. For example, the distribution system 110 may assign the time segments to a channel according to availability of each channel to provide periodic broadcasts. The content guide service 126 may assign the time segments to a channel in order to ensure accommodation of other scheduled broadcasts. The content provider 112 may assign the time segments to a channel according to a priority of the content item in relation to other content items provided by the content provider 112.

At block 506, each of the time segments are assigned to a periodic time slot of that segment's assigned channel. As described above in reference to FIG. 4b, the time segments may be ordered in any way, as long as a delay between broadcasts of each time segment is no more than the length of time defined in equation (5). To accomplish this, time segments to be broadcast on each channel must be interleaved with other time segments to be broadcast on that channel. All of the time slots of a channel may be filled, or time slots may be left vacant according to the number of segments and/or the design of the system 100.

In some embodiments, the assignment of the time segments to channel time slots is optimized, such as to reduce the number of segments that will have to be stored when receiving the content item. Those skilled in the art will know how to identify and perform other such optimizations.

The time segments may be assigned to channel time slots by different devices or modules within the system 100. For example, the distribution system 110 may assign the time segments to channel time slots according to availability of each segment before broadcast. The content guide service 126 may assign the time segments to channel time slots while referring to other programs that are being broadcast that may need to be stored to be properly viewed. The content provider 112 may assign the time segments to channel time slots according to the a priority of each time segment in relation to other time segments of the content item.

At block 508, the time segments are periodically broadcast over their assigned channels. The periodic broadcasts are executed during the time slots assigned at block 506, described above. Two or more of the segments may be broadcast concurrently on different channels, as described above in reference to FIGS. 4a and 4b. In this way, the content item can be broadcast and received in less time than the duration of the entire content item. In some embodiments, a plurality of the time segments are broadcast substantially simultaneously with each other.

The time segments are broadcast over a communications link in the broadcast system 100, such over the content communication link 108 or the second communication link 106. The broadcast is performed by a broadcast device, such as a device used in implementation of the distribution system 110. The distribution system 110 may be a single distribution system or may include multiple local distributions systems.

Information identifying the specific content item from which the time segment was derived or the order of the time segment within the content item, among other data, may also be broadcast with the time segments. Such information may be provided to the distribution system 110, such as by the content guide service 126 or the content provider 112, or the distribution system 110 may itself determine the information.

Those of skill in the art will appreciate that the content item is thus periodically provided for uninterrupted display or playback over a plurality of channels. As described above, the content item may be a movie or television show. In this case, the content item may be broadcast as a digital video. Hence, videos can be provided in nearly on demand. Other content items that may be periodically broadcast include pictures, digital music files, and other multimedia content.

Returning now to description of FIG. 5, a request for an initial time segment of the content item may be received and the initial time segment transmitted at optional block 510. The request may be received, for example, over the second communication link 106. In this example, the initial time segment may be broadcast, such as over the content communication link 108, or may be transmitted over the second communication link 106. In some embodiments, the initial time segment is transmitted directly to one or more requesting devices over the second communication link 106.

Those of skill in the art will appreciate that transmission of the initial time segment can be commenced before periodic broadcast of the content item begins. Alternatively, the initial time segment can be transmitted while the content item is being periodically broadcast. In this way, an initial time segment may be provided to a requester such that the requester can begin receiving the content item almost immediately. Periodic broadcast of the content item continues after transmission of the initial segment, so the entirety of the content item will be provided for uninterrupted playback thereafter. In this way, the broadcast systems and methods described herein can not only provide near on demand video and content, but can also be used to provide on demand video and content.

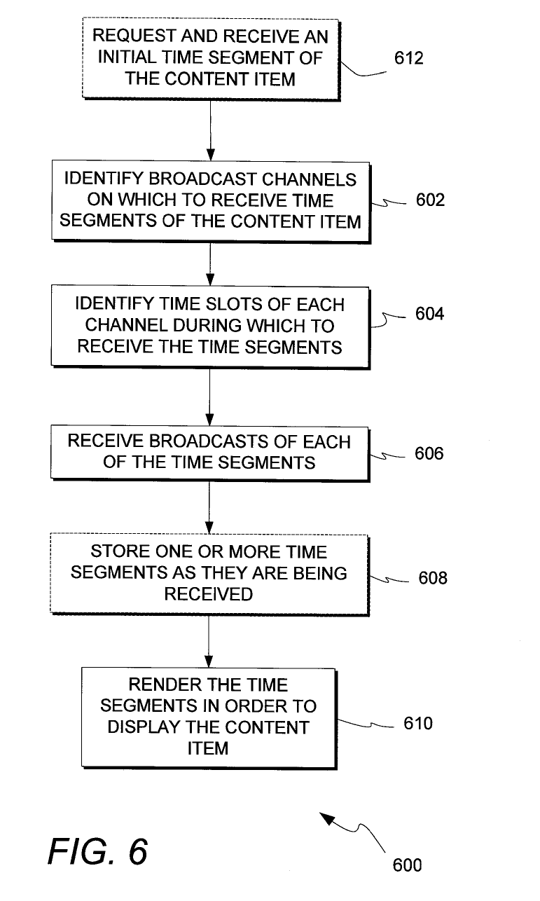

FIG. 6 is a flowchart illustrating a method 600 of receiving a content item at an electronic device, such as the mobile device 102 illustrated in FIG. 2. The acts or events associated with the method 600 may be performed by different configurations of the mobile device 102 than those herein described. Those skilled in the art will know how to extend the method described to different configurations of the mobile device 102 and will understand that different components within the mobile device 102 may perform the method than are herein described.

At block 602, the mobile device 102 identifies broadcast channels on which to receive time segments of a content item. Information regarding the broadcast channels may be transmitted to the mobile device 102, such as over the content communication link 108 or over the second communication link 106. Such information may be transmitted by the content guide service 126 or by the content provider 112. The mobile device 102 may receive the information using the network interface 208 or the second network interface 206. In other embodiments, the information identifying the broadcast channels may already be stored on the mobile device, such as in the electronic content guide 124. The information identifying the broadcast channels may be stored alone or in combination with the electronic content guide 124 in the storage 204.

At block 604, the mobile device 102 identifies time slots of each channel during which to receive the time segments. Information identifying the time slots may be transmitted to and received by the mobile device 102 similar to the information identifying the broadcast channels. Information identifying the time slots may also be stored on the mobile device 102 similar to the information identifying the broadcast channels.

In some embodiments, time slots at which to receive the time segments will not be dictated to the mobile device 102, but a general schedule of when the segments will be available is provided to the mobile device 102. From this schedule, the mobile device 102 can determine when to receive certain of the time segments. Such decision can be based on other scheduled reception of information, based on capabilities of the mobile device 102, or based on availability of resources within the mobile device 102, for example. The determination may in some instances be made after the mobile device 102 has begun receiving the segments, as will be described below.

At block 606, the mobile device 102 receives broadcasts of each of the time segments, such as using the receiver 224 to receive the broadcasts over the content communication link 108. The time segments are received according during the time slots identified at block 604. In some cases, the mobile device 102 may still need to determine when an appropriate time slot is available to receive a particular segment, as will be described below.

The time slots determined at block 604 may overlap or may occur at a substantially simultaneous time, as can be seen in FIGS. 4a and 4b. Thus, the receiver 224 may be configured to concurrently receive a plurality of segments over separate channels. The processor 202 may also or instead be configured to cause the receiver 224 to receive segments concurrently over separate channels.

The receiver 224 may be configured to receive other information regarding the content item or segments separate from or concurrently with receiving one or more segments. For example, the receiver 224 may receive information identifying the content item from which each segment is derived and information identifying the segment's order within the content item. Alternatively, the mobile device 102 may identify the appropriate content item of each segment and the order of the segment within the content item from information already stored on the mobile device 102, such as from information stored in the electronic content guide 124. Error checking data may be appended to the segments to ensure accurate reception of the segments.

At optional block 608, the mobile device 102 may store one or more time segments as they are being received. For example, the processor 202 may be configured to store a time segment in the storage 204 as it is being received by the receiver 224. In some instances, the time segment will be received concurrently with another time segment. Thus, the processor 202 may be configured to store a time segment as it is being received concurrently with at least one other time segment.

At block 610, the mobile device 102 renders the time segments in order, so as to display the content item. The time segments are rendered by the rendering module 122, and may be displayed on the display 210 and/or output from the loudspeaker 214. The mobile device 102 is configured to stream time segments. Thus, the rendering module 122 is configured to render a time segment as the time segment is being received by the receiver 224, for example.

The mobile device 102 is also configured to render previously stored time segments. For example, the processor 202 may be configured to retrieve time segments from the storage 204 in order for the rendering module 122 to render the time segment. In this way, previously stored time segments, or portions thereof, can be rendered on the mobile device 102 at an appropriate time.

The time segments received by the mobile device 102 are rendered in order. This order is not necessarily the order in which the time segments were received, but rather the order of the time segment within the content item. The order is based on the way in which the time segments were derived from the content item or the way in which the content item was divided into time segments. Rendering the time segments in order ensures uninterrupted display of the content item from beginning to end. Information regarding the order in which to display the time segments may be received by the mobile device 102, such as at block 606 or at some other time, or the information may already be stored on the mobile device 102, as described above.

By streaming certain of the time segments and by receiving and storing other time segments for later rendering from storage, the mobile device 102 can ensure that time segments broadcast and received over a plurality of periodic times, such as illustrated in FIGS. 4a and 4b, will be displayed in an appropriate manner to a user of the mobile device 102. An example of the order in which these steps of receiving, storing, and rendering of time segments might be completed was described above in reference to FIG. 4a. Those of skill in the art will understand other orders in which the segments illustrated in FIG. 4a may be received, stored, and rendered, and will know how to extend the described receiving, storing, and rendering, to broadcasts of content items different from the broadcast described in reference to FIG. 4a.

Of course, the mobile device 102 may not display the content item in an uninterrupted manner. The mobile device 102 may receive the segments so that the content item may be displayed in an uninterrupted manner, but the mobile device 102 may determine that such display is undesired. For example, the mobile device 102 may stop or pause display of the content item when receiving an incoming telephone call or when experiencing another event. The reception of the segment may be maintained during this time to ensure availability of the content item, but display may be halted. In a case where all of the segments have been received when the event is experienced, display merely has to be paused and can be resumed by rendering the segments from the storage 204 after completion of the event.

Description will now be made of a situation in which the mobile device 102 may delay determining which time slot is appropriate for receiving a certain segment of the content item. Referring to FIG. 4a, consider an example where the mobile device 102 begins receiving the content item at the beginning of Time 2. At Time 2, the mobile device 102 will stream Segment 1. Also at Time 2, the mobile device 102 may receive and store Segment 3 and/or Segment 5. However, the mobile device 102 will also have the ability to stream Segments 3 and 5 at Times 4 and 6, respectively. Thus, it must be determined whether the mobile device 102 is to receive and store Segment 3 and/or Segment 5 at Time 2, or whether these segments will be streamed at a later time. Other situations in which the mobile device 102 may delay determining an appropriate time slot will be recognized by those skilled in the art.

The determination of when to receive a segment may be predetermined by the mobile device 102 or a device external to the mobile device 102, or may be determined by the mobile device 102 as necessary. For example, the device 102 may determine a reception schedule before any segments are receiving using the processor 202 and/or the electronic content guide 124, for example. Also, an external device, such as the content guide service 126, may determine a reception schedule for the mobile device 102.

To add to this, the mobile device 102 may determine when to receive segments as necessary. For example, the mobile device 102 may determine at the beginning of Time 2 that there is insufficient space in the storage 204 to store both Segment 3 and Segment 5. At this time, the mobile device 102 may determine which of the segments to store and may then proceed to receive and store the determined segment. The other segment will be streamed at the appropriate time later. As described above, determination may be based on scheduled reception of other information, capabilities of the mobile device 102, or availability of resources within the mobile device 102, among other factors as will be recognized by those of skill in the art.

Those of skill in the art will appreciate that a content item may thus be received by the mobile device 102 over a plurality of channels. In order to begin receiving the content item, a user of the mobile device 102 will have to wait at most a length of time that is equal to the delay between periodic broadcasts of an initial segment of the content item. After the mobile device 102 has received at least a portion of the initial time segment, rendering of the content item by the mobile device 102 will be uninterrupted. Thus, videos or other content can be received by the mobile device 102 nearly on demand.

Returning now to description of FIG. 6, the mobile device 102 may request and receive an initial time segment of the content item at optional block 612. For example, the transmitter 222 may be used to transmit a request over the over the second communication link 106. In response to the request, a broadcast initial segment may be received over the content communication link 108, or an initial segment may be directly received by the receiver 220, such as over the second communication link 106.

Requesting and receiving a time segment in the above described ways may allow the mobile device 102 to begin reception of the content item before the next scheduled periodic broadcast of the first segment of the content item. Upon receiving at least a portion of the initial segment, the mobile device 102 can begin rendering the content item, such as by using the rendering module 122. At the time of the next periodic broadcast of segments of the content item, the mobile device 102 can begin receiving segments of the content item according to the broadcast schedule, such as over the content communication link 108 by using the receiver 224. Such receiving may begin before the mobile device 102 has completed receiving the requested initial segment. In this case, segments or portions thereof received according to scheduled broadcasts may be stored on the mobile device 102, such as in the storage 204, for later rendering by the mobile device 102.

Although the block 612 is illustrated as being executed before block 602, block 612 may be executed at any time relative to any of blocks 602 and 604. For example, an initial segment of the content item may be requested and direct reception of the initial segment started before broadcast channels are identified. Alternatively, the broadcast channels may first be identified, and then the initial segment requested and received. In another example, the initial segment may be requested and received after broadcast channels and times slots of each broadcast channel are identified. This order of events may be advantageous when the mobile device 102 determines that a substantial wait will be required before receiving broadcast segments at the identified time slots.

Those of skill in the art will appreciate that reception of the initial time segment can be commenced before periodic broadcast of the content item begins. Alternatively, the initial time segment can be received while the content item is being periodically broadcast or between periodic broadcasts of the content item. In this way, an initial time segment can be rendered by the mobile device 102 such that playback of the content item can commence almost immediately. Periodic reception of broadcast segments of the content item continues after reception of the initial segment, so the entirety of the content item will be provided for uninterrupted playback thereafter. In this way, electronic devices and methods described herein can not only receive near on demand video and content, but can also be used to receive on demand video and content.

Those skilled in the art will appreciate that content items can thus be broadcast and received over a plurality of channels more efficiently than known in the prior art. The content item can periodically be made available for uninterrupted playback utilizing a fewer number of channels. In addition, the content item can be provided more often than in the prior art without unduly burdening the broadcast system. To add to this, a device receiving the content item may receive the content item over a shorter period of time. Thus, the resources of the device will be free for other tasks. In addition, if playback of the content item is disrupted after the device has already received all segments of the content item, playback can be resumed later using stored segments.

Those skilled in the art will appreciate that the apparatuses, systems, and methods of the disclosure may be used to provide near video on demand or to approximate on demand video using periodic broadcast of time segments. Specifically, the system of the disclosure reduces the number of channels and time required to periodically broadcast a content item. Accordingly, instead of occupying network capacity for delivering an entire content item for each delay period, segments can be provided during every period. Thus, a content item can be periodically provided for uninterrupted playback.

Those of skill in the art will appreciate that although the above disclosure illustrated embodiments of the invention in reference to the system 100 and the mobile device 102, the invention is not limited to such devices. Other electronic devices that implement embodiments of the invention may be used in systems that include providing pay-per-view television and movies via cable and satellite means. In some instances, devices embodying the present invention may be used in the transmission and reception of content over the Internet. The present invention is of course not limited to these examples, and those of skill in the art will appreciate other devices that may implement embodiments of the invention.

Any illustrative logical blocks, modules, and circuits described in connection with the embodiments disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Those skilled in the art will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the above detailed description has shown, described, and pointed out novel features of the invention as applied to various embodiments, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

What is claimed is:

1. A method of transmitting a content item, the method comprising:
identifying a plurality of successive time segments of the content item, wherein each of the time segments is of substantially the same duration;
assigning each of the plurality of time segments to one of a plurality of channels, wherein the number of channels is less than the number of time segments;
assigning each of the time segments to a periodic time slot of its respective channel; and
periodically broadcasting each of the time segments of the content item on the respective assigned channel and in the respective assigned time slot,
whereby the content item is made available for uninterrupted playback subsequent to receipt by a receiver of a first portion of the content item.

2. The method of claim 1, wherein a first of the segments is periodically broadcast on a first of the channels, a second and third of the segments is periodically broadcast on a second of the channels concurrently with the broadcasting on the first channel, and remaining ones of the segments are periodically broadcast on at least a third of the channels concurrently with the broadcasting on the first and second channels.

3. The method of claim 1, wherein the number of segments is between 4 and 7 and the number of channels is 3.

4. The method of claim 1, wherein the number of time segments is between 4 and 7 and the plurality of channels comprises three channels, and wherein a first of the segments is periodically broadcast on a first of the channels, a second and third of the segments is periodically broadcast interleaved on a second of the channels concurrently with the broadcasting on the first channel, and remaining ones of the segments are periodically broadcast interleaved on at least a third of the channels concurrently with the broadcasting on the first and second channels.

5. The method of claim 1, wherein the channels are logical channels defined by at least one of a frequency band of the broadcast, modulation of a signal of the broadcast, and a code associated with a signal of the broadcast.

6. The method of claim 1, wherein the number of segments is N and the number of concurrent channels is between └Log₂(N)┘ and ┌Log₂(N+1)┐.

7. The method of claim 1, further comprising:
receiving a request for an initial one of the time segments of the content item; and
transmitting, prior to the next periodic broadcast, the initial time segment of the content item in response to receiving the request for the content item, whereby the content item is made available for uninterrupted playback upon receiving at least a portion of the initial time segment.

8. The method of claim 7, wherein the requested at least one segment comprises an initial time segment of the content item.

9. The method of claim 7, wherein the steps of receiving and transmitting are performed via a bidirectional network.

10. The method of claim 9, wherein the bidirectional network comprises at least one of a TCP/IP network, a WiFi network, a CDMA2000 network, a EV-DO network, a UMTS network, or a WiMax network.

11. The method of claim 9, wherein broadcasting comprises broadcasting a digital video signal.

12. The method of claim 1, wherein the broadcasting comprises broadcasting at least two time segments of the content item simultaneously.

13. A method of receiving a content item, the method comprising:
identifying a plurality of broadcast channels and a respective one of a plurality of time slots of each channel on which a plurality of time segments of the content item are broadcast, wherein the number of channels is less than the number of time segments and wherein the time segments are each of substantially the same duration; and
receiving broadcasts of each of the time segments of the content item on the respective identified broadcast channel and during the respective identified time slot, wherein during at least one of the time slots receiving each of the time segments comprises receiving respective time segments on at least two of the identified channels concurrently.

14. The method of claim 13, wherein the number of segments is between 4 and 7 and the number of channels is 3.

15. The method of claim 13, wherein the channels are logical channels defined by at least one of a frequency band of the broadcast, modulation of a signal of the broadcast, and a code associated with a signal of the broadcast.

16. The method of claim 13, further comprising:
requesting an initial one of the time segments of the content item; and
receiving, prior to the next periodic broadcast of the initial time segment, at least a portion of the initial time segment of the content item in response to requesting the initial time segment; and
providing the content item for uninterrupted playback upon receiving the at least a portion of the initial time segment.

17. The method of claim 16, wherein the requested at least one segment comprises an initial time segment of the content item.

18. The method of claim 16, wherein the steps of requesting and receiving are performed via a bidirectional network.

19. The method of claim 18, wherein the bidirectional network comprises at least one of a TCP/IP network, a WiFi network, a CDMA2000 network, a EV-DO network, a UMTS network, or a WiMax network.

20. The method of claim 18, wherein receiving the broadcast comprises receiving a broadcast a digital video signal.

21. The method of claim 13, wherein the number of segments is N, and wherein said receiving comprises receiving respective time segments of the content item concurrently over ┌Log₂(N+1)┐ channels.

22. A system for transmitting a content item, the system comprising:
means for identifying a plurality of successive time segments of the content item, wherein each of the time segments is of substantially the same duration;
means for assigning each of the plurality of time segments to one of a plurality of channels, wherein the number of channels is less than the number of time segments;
means for assigning each of the time segments to a periodic time slot of its respective channel; and
means for periodically broadcasting each of the time segments of the content item on the respective assigned channel and in the respective assigned time slot such that the content item is available for uninterrupted playback subsequent to a broadcast first broadcast segment being received by a receiver.

23. A computer readable medium storing executable instructions for causing at least one computer to:
identify a plurality of successive time segments of the content item, wherein each of the time segments is of substantially the same duration;
assign each of the plurality of time segments to one of a plurality of channels, wherein the number of channels is less than the number of time segments;
assign each of the time segments to a periodic time slot of its respective channel; and
periodically broadcast each of the time segments of the content item on the respective assigned channel and in the respective assigned time slot,
whereby the content item is made available for uninterrupted playback subsequent to receipt by a receiver of a first portion of the content item.

24. An apparatus for receiving broadcast programs, comprising:
a receiver configured to receive broadcasts of a program, wherein the receiver is configured to receive concurrently on at least two channels;
a storage configured to store broadcast programs; and
a processor configured to:
identify a plurality of channels and a respective one of a plurality of time slots of each channel on which a plurality of time segments of the content item are broadcast, wherein the number of channels is less than the number of time segments and wherein the time segments are each of substantially the same duration; and
receive via the receiver each of the time segments of the content item on the respective identified channel and during the respective identified time slot, wherein during at least one of the time slots receiving each of the time segments comprises receiving respective time segments on at least two of the identified channels concurrently.

25. The apparatus of claim 24, wherein the processor is configured to receive via the receiver between 4 and 7 segments on three channels.

26. The apparatus of claim 24, wherein the receiver is configured to receive broadcast digital video signals over a bidirectional network.

27. An apparatus for receiving broadcast programs, comprising:
means for identifying a plurality of broadcast channels and a respective one of a plurality of time slots of each channel on which a plurality of time segments of the content item are broadcast, wherein the number of channels is less than the number of time segments and wherein the time segments are each of substantially the same duration; and
means for receiving broadcasts of each of the time segments of the content item on the respective identified broadcast channel and during the respective identified time slot, wherein during at least one of the time slots receiving each of the time segments comprises receiving respective time segments on at least two of the identified channels concurrently.

28. A method for making available a content item over a plurality of equal delay period start times, comprising:
dividing the item into substantially equally sized sections, the size of each section corresponding to a size of the delay between start times, and each section having a section order less than the number of sections;
assigning each section to a channel such that the section is repeated with a delay that is at most equal to the section order multiplied by the delay period;
broadcasting section data corresponding to each assigned channel in accordance with the assigning to provide the content item to a receiver device with a start time having a delay equal to the delay period.

29. The method of claim 28, wherein the number of sections is N, and wherein each section has a section order of at most Log₂(N+1).

30. A computer readable medium storing executable instructions for causing at least one computer to:
divide the item into substantially equally sized sections, the size of each section corresponding to a size of the delay between start times, and each section having a section order less than the number of sections;
assign each section to a channel such that the section is repeated with a delay that is at most equal to the section order multiplied by the delay period;
broadcast section data corresponding to each assigned channel in accordance with the assigning to provide the content item to a receiver device with a start time having a delay equal to the delay period.

31. A method for making available a content item over a plurality of equal delay period start times, comprising:
dividing the item into substantially equally sized sections, the size of each section corresponding to a size of the delay between start times, and each section having a section order less than the number of sections;
broadcasting a first section repeatedly over a first broadcast channel such that the repetition rate is equal to the size of the delay between start times; and
broadcasting the subsequent sections over at least a second broadcast channel such that each section is repeated with a delay that is at most equal to the section order multiplied by the delay period, wherein a channel capacity of each broadcast channel is optimized by interleaving sections within the broadcast channel to provide the content item over a plurality of delay period start times.

32. The method of claim 31, wherein the number of sections is N, and wherein each section has a section order of at most Log₂(N+1).

33. A computer readable medium storing executable instructions for causing at least one computer to:
divide the item into substantially equally sized sections, the size of each section corresponding to a size of the delay between start times, and each section having a section order less than the number of sections;
broadcast the first section repeatedly such that the repetition rate is equal to the size of the delay between start times; and
broadcast the subsequent sections such that each section is repeated with a delay that is at most equal to the section order multiplied by the delay period, wherein a channel capacity of each broadcast channel is optimized by interleaving sections within the broadcast channel to provide the content item over a plurality of delay period start times.

34. A system for making available a content item over a plurality of equal delay period start times, comprising:
means for dividing the item into substantially equally sized sections, the size of each section corresponding to a size of the delay between start times, and each section having a section order less than the number of sections; and
means for broadcasting the sections such that each section is repeated with a delay that is at most equal to the section order multiplied by the delay period,
wherein the complete content item is broadcast during any time period starting with one of the start times and ending at most an amount of time later equal to the highest section order multiplied by the delay period.

35. The system of claim 34, further comprising:
means for assigning each section to a channel such that the section is repeated with a delay that is at most equal to the section order multiplied by the delay period; and
means for broadcasting section data corresponding to each assigned channel in accordance with the assigning to provide the content item to a receiver device with a start time having a delay equal to the delay period.

36. The system of claim 34, wherein the means for broadcasting the sections comprises:
means for broadcasting a first section repeatedly over a first channel such that the repetition rate is equal to the size of the delay between start times; and
means for broadcasting the subsequent sections over at least a second channel such that each section is repeated with a delay that is at most equal to the section order multiplied by the delay period, wherein a channel capacity of each broadcast channel is optimized by interleaving sections within the broadcast channel to provide the content item over a plurality of delay period start times.

37. A method for making available on a device a content item having one of several start times, the device receiving data from a broadcast source, comprising:
receiving a first section of a plurality of sections of the content item, each section of said plurality of sections associated with data identifying the content item, and each section of said plurality of sections associated with a section replay order;
rendering the first section on the device;
identifying at least one other section of said plurality of sections;
receiving and storing the at least one other section simultaneously with said rendering of the first section; and
rendering the at least one other section by reference to the section replay order of the at least one other section.

38. An apparatus for receiving broadcast content items having one of several start times, comprising:
a storage;
a receiver configured to receive a first section of a plurality of sections of a content item from a broadcast source, each section of said plurality of sections associated with data identifying the content item, and each section of said plurality of sections associated with a section replay order;
a processor configured to store the section replay order in the storage and configured to identify at least one other section of said plurality of sections; and
a display configured to render the first section;
wherein the receiver is configured to receive the at least one other section and the processor is configured to store the at least one other section in the storage simultaneously with the first section being rendered on the display, and
wherein the display is configured to render the at least one other section from storage and in reference to the stored section replay order.

39. A method for providing a content item on a device, comprising:
receiving a first section of a plurality of sections of the content item over a first broadcast channel, each section of said plurality of sections associated with data identifying the content item, and each section of said plurality of section associated with a section replay order;
identifying that a section of said plurality of sections having a final section order is provided on another broadcast channel; and
recording said section having a final section order simultaneously with rendering said first section.

40. An apparatus for receiving broadcast content items, comprising:
a storage;
a receiver configured to receive a first section of a plurality of sections from a broadcast source over a first broadcast channel, each section of said plurality of sections associated with data identifying the content item, and each section of said plurality of sections associated with a section replay order; and
a processor configured to store the section replay order in the storage and configured to identify that a section of said plurality of sections having a final section order is provided on another broadcast channel; and
a display configured to render the first section;
wherein the processor is configured to record the section having the final section order in the storage simultaneously with the first section being rendered on the display.

41. An apparatus for receiving a broadcast content item having one of several start times, comprising:
means for receiving a first section of a plurality of sections of the content item, each section of said plurality of sections associated with data identifying the content item, and each section of said plurality of sections associated with a section replay order;
means for rendering the first section on the device; and
means for receiving and storing at least one other section simultaneously with said rendering of the first section.

42. The apparatus of claim 41, further comprising:
identifying at least one other section of said plurality of sections than said first section; and
means for rendering the at least one other section by reference to the section replay order of the at least one other section.

43. The apparatus of claim 41, wherein said means for receiving a first section comprises means for receiving a first section over a first broadcast channel, the apparatus further comprising:
means for identifying that a section of said plurality of sections having a final section order is provided on another broadcast channel,
wherein said means for receiving and storing at least one other section comprises means for recording said section having the final section order simultaneously with rendering said first section.
